(19) United States
(12) Patent Application Publication
(10) Pub. No.: US 2024/0286888 A1
(43) Pub. Date: Aug. 29, 2024

(54) AUTOMATED TRENCH MANUFACTURING AND ASSEMBLY FOR ATTACHING TRIM COVERS TO A CUSHION ASSEMBLY

(71) Applicant: Lear Corporation, Southfield, MI (US)

(72) Inventors: Curtis HUDSON, Macomb, MI (US); Lisa SWIKOSKI, West Bloomfield, MI (US); Michelle A. PERENY, Farmington Hills, MI (US); Jaiviknesh KANDASAMY, Southfield, MI (US)

(21) Appl. No.: 18/176,164

(22) Filed: Feb. 28, 2023

(51) Int. Cl. B68G 7/12; A47C 7/24

(52) U.S. Cl. CPC B68G 7/12; A47C 7/24

(57) ABSTRACT

Cushions, methods, and manufacturing systems for making the same are disclosed. The cushions may be foamless such as being made from a body of entangled and/or intertwined polymeric strands. The manufacturing systems may include a die such as die bars having a plurality of orifices that cooperate with a plurality of receptacles and actuators for discharging a plurality of fasteners from the receptacles, through the die into the cushions. In a refinement, the die may be heated such that a skinned over membrane is created in the cushion to retain the plurality of fasteners. A trim cover may cooperate with the plurality of fasteners such that it is attached to the cushion.

### TECHNICAL FIELD

Foamless cushion assemblies with trenches (i.e., cavities, channels, or depressions) and fasteners disposed therein are disclosed. Method and assemblies for making the same are also disclosed.

### BRIEF DESCRIPTION OF THE DRAWINGS

FIG. 1 is a perspective view of a cushion assembly and a manufacturing assembly for making the same.

FIG. 2 is a partial cross-sectional view of the manufacturing assembly engaging a cushion before actuation.

FIG. 3 is a partial cross-sectional view of the manufacturing assembly engaging a cushion after actuation.

FIG. 4 is a top view of the manufacturing assembly engaging a cushion assembly.

FIG. 5 is a top view of the cushion of FIG. 4 after engagement by the manufacturing assembly.

FIG. 6 is an exploded view of a portion of the manufacturing assembly.

FIG. 7 is front view of the cushion and cushion assembly before engagement.

FIG. 8 is a front view of the cushion and cushion assembly during engagement.

FIG. 9 is a flow chart illustrating a method of making a cushion assembly.

FIG. 10 is a partial cross-section perspective view of a seat assembly.

FIG. 11 is a perspective view of an embodiment of a fastener.

FIG. 12. is a perspective view of a foamless cushion having a trench therein.

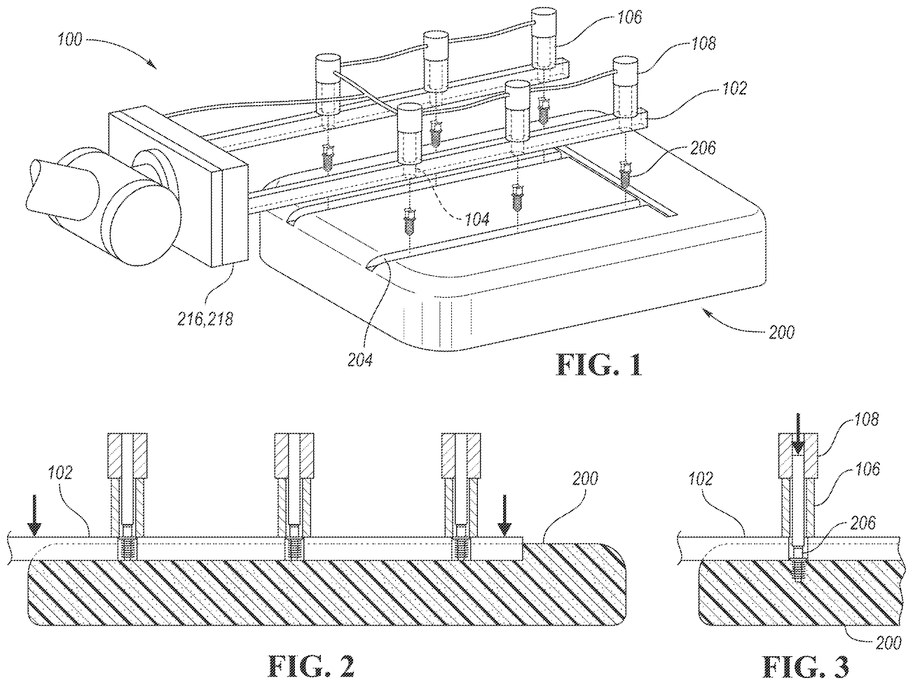

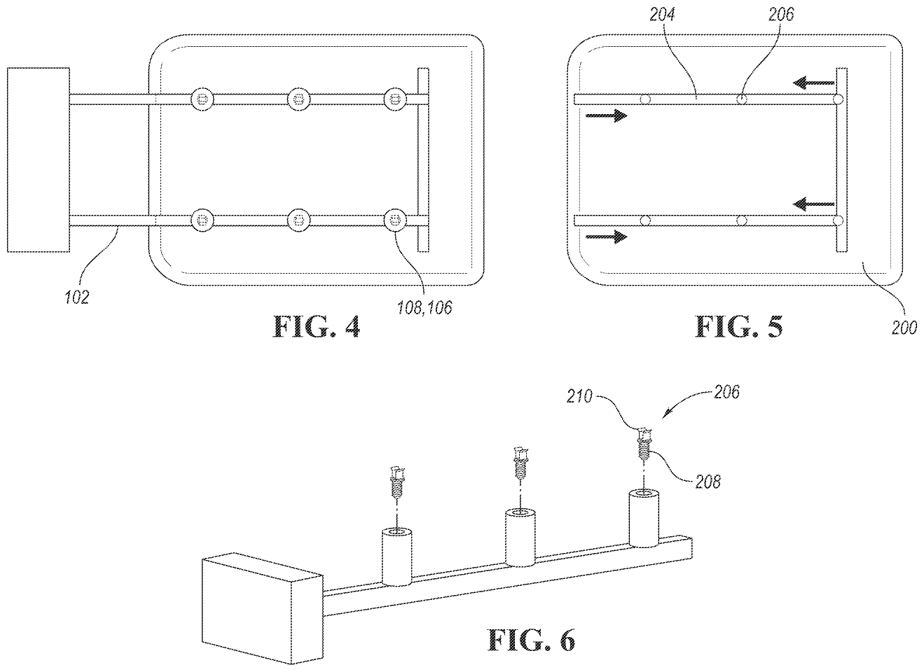

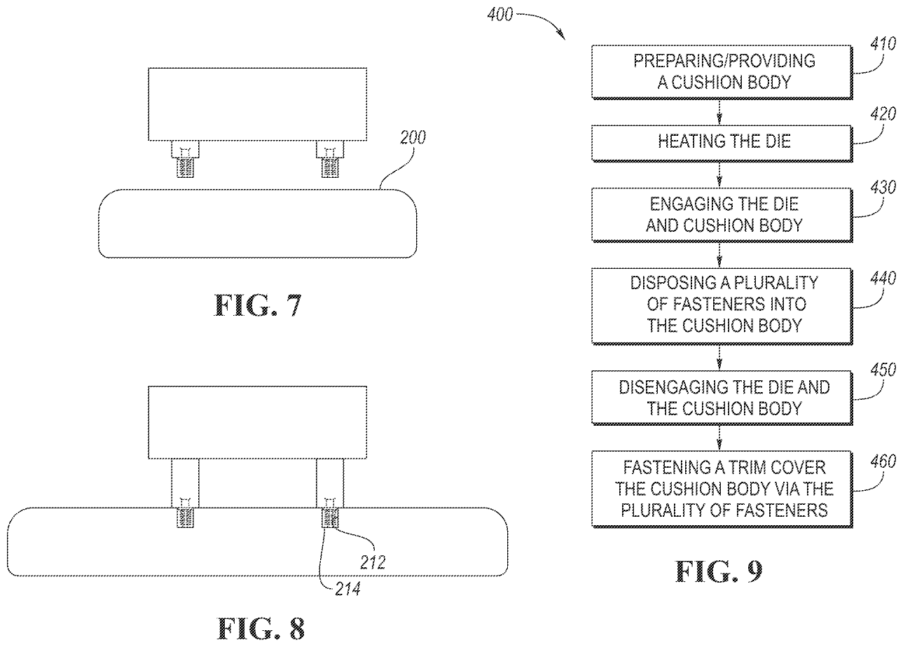

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary: percent, “parts of,” and ratio values are by weight. The term “polymer” includes “oligomer,” “copolymer,” “terpolymer,” and the like. The description of a group or class of materials as suitable or preferred for given purpose implies the mixtures of any two or more of the members of the group or class are equally suitable or preferred. Molecular weights provided for any polymers refers to number average molecular weight. A description of constituents in chemical terms refers to the constituents at the time of addition to any combination specified in the description and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

The term “substantially” or “generally” may be used herein to describe disclosed or claimed embodiments. The term “substantially” or “generally” may modify a value or relative characteristic disclosed or claimed in the present disclosure. In such instances, “substantially” or “generally” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

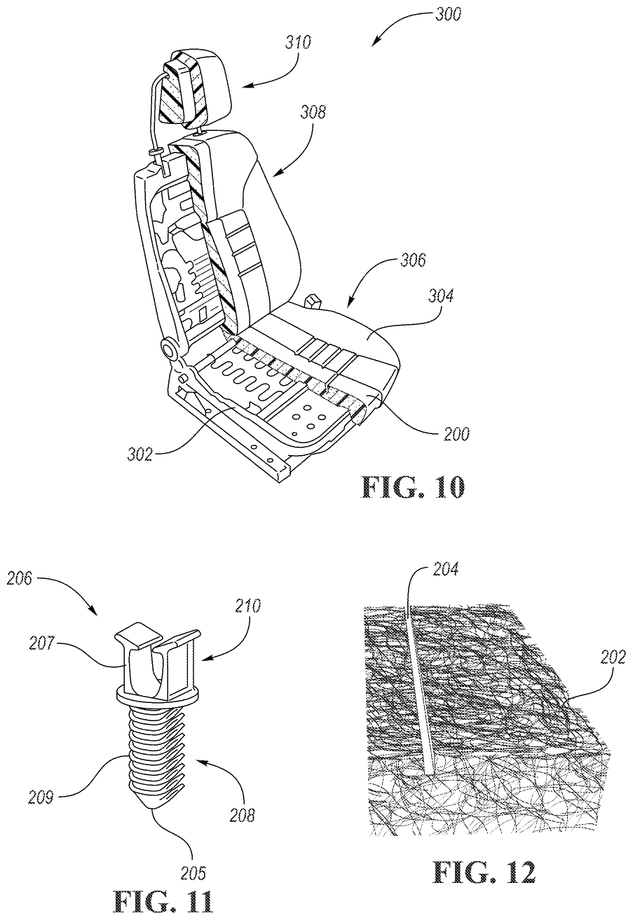

Referring to FIG. 1, a manufacturing assembly 100 to produce a molded assembly such as a cushion assembly 200 is disclosed. In a refinement, the cushion assembly 200 is disposed in a seat assembly 300, as shown in FIG. 10. For example, the seat assembly 300 is for a vehicle (e.g., motorcycle, automobile, locomotive, aircraft, and/or watercraft). The manufacturing assembly 100 includes a die 102 having one or more orifices 104 with corresponding receptacle(s) 106 and/or actuator(s) 108 disposed therewith. The cushion assembly 200 comprises a cushion 202 such as a foam or foamless cushion. In a refinement, the cushion 202 is foamless, i.e., includes a body made up of a plurality of entangled and/or intertwined polymeric strands such that it is foamless, as shown in FIG. 12. In a variation, the manufacturing assembly is used to define one or more trenches 204 (e.g., a plurality, two, three, four, etc.) in the cushion 202 and to dispose one or more fasteners 206 (e.g., a plurality, two, three, four, etc.) in each trench 204 (i.e., depressed channel) of the cushion 202. The fasteners 206, for example, cooperate with a trim cover 304 to secure the trim cover 304 to the cushion assembly 200. In a variation, the one or more trenches 204 extend along the cushion such that when arranged in a vehicle seat they extend from the seat front towards the seat back.

Referring to FIG. 10, the seat assembly 300 includes a seat frame 302 supporting the cushion assembly 200 and a trim cover 304 disposed over the cushion assembly 200. In a variation, the seat assembly 300 includes a seat bottom 306, a seat back 308, and a head rest 310. In a refinement, the trim cover 304 cooperates with the cushion assembly 200 via the one or more fasteners 206. For example, in various embodiments, the fasteners 206 have a penetrating portion 208 and a cooperating portion 210, as shown in FIG. 11. In a refinement, the penetrating portion 208 has a tapered tip such as a pointed tip 205 and one or more retaining elements 209 such as barbs, or flat ridges that extend along the periphery. In various embodiments, the cooperating portion 210 includes a clip 207 to attach the fastener 206 to the trim cover 304. In a variation, the trim cover 304 has corresponding fasteners 206 that cooperate with the fasteners 206 of the cushion assembly 200. For example, the fasteners of the trim cover 304 snap into the clips 207 of the fasteners 206 disposed in the cushion assembly 200.

In various embodiments, the cushions 202 are free of foam or foamless. For example, the cushions 202 are made of a body of entangled or intertwined polymeric strands/filaments such as those discussed in the U.S. patent application identified by Ser. No. 17/741,639 and filed May 11, 2022, which is hereby incorporated by reference in its entirety. In a refinement, the trenches 204 of the foamless cushion are delimited by a lateral wall 212 and a floor portion 214 that have skinned over (i.e., the individual strands have deformed such as from pressure and heat) to form a membrane (i.e., lateral wall membrane and floor membrane). In various embodiments, the membrane has a minimum thickness of at least 1.75 mm, or more preferably at least 2.0 mm, or even more preferably at least 2.25 mm such that it sufficiently retains the one or more fasteners 206. In one or more embodiments, the fasteners 206 are Christmas tree fasteners with a clip 207 at the end such that they cannot be retained in the foamless cushion unless a skinned over membrane is formed. In still other embodiments, the thickness proximate the one or more fasteners 206 is at least 1.75 mm, or more preferably at least 2.0 mm, or even more preferably at least 2.25 mm. In a refinement, the fasteners 206 are made of a material having a low melting and/or softening point (e.g., less than 150° C., or more preferably less than 250° C., or even more preferably less than 350° C.) such as plastic (e.g., polyethylene, polypropylene, polystyrene, polyurethane, polyvinyl chloride, polyacrylates, acrylics, polyolefins).

In one or more embodiments, a manufacturing assembly or system 100 includes a die 102 such as one or more die bars to define one or more trenches 204 in the cushion 202, receptacles 106 (to receive the fasteners 206 before they are disposed in the cushion 202) cooperating with the die 102, and one or more actuators 108 cooperating with the receptacles 106 and/or fasteners 206 to dispose them into the cushion 202. In a refinement, the manufacturing assembly or system 100 includes a heating element 216 in communication with the die 102 such that the die 102 may be heated during operation. In a refinement, the die 102 is heated to or above a threshold temperature. In various embodiments, an ultrasonic heater is used. For example, the die 102 is heated to at least 100° C., or more preferably at least 105° C., or even more preferably at least 110° C. In various embodiments, the die includes a thermal conductor such as metal (e.g., steel, aluminum, iron, or copper). In a refinement, the die 102 has a thermal conductivity of at least 25 W/m·K, or more preferably at least 50 W/m·K, or even more preferably at least 100 W/m·K. In yet another embodiment, the manufacturing assembly 100 includes an adaptor such as an adaptor plate to attach the manufacturing assembly 100 as an end effector to an automation system. For example, the manufacturing assembly 100 cooperates with the automation system. The manufacturing assembly 100, for example, cooperates with one or more robotic arm 218 to move the die 102 such that it engages the cushion 202 and disengages the cushion 202. In a variation, the robotic arm 218 applies the die 102 to the cushion 202 at a pressure of at least 60N, or more preferably at least 75N, or even more preferably at least 80N. In various embodiments, the heat and/or pressure defines the one or more trenches 204 such as by deforming, molding, cutting, and/or carving the cushion 202.

In various embodiments, the die 102 includes one or more orifices 104 extending from a first side to a second side of the die 102 and sized such that the fastener(s) 206 may pass through the die 102. In a refinement, a receptacle 106 is disposed over and/or aligned with each orifice 104 such that the receptacle 106 may receive and hold a fastener 206 until it is disposed in the cushion 202. The one or more receptacles 106 cooperate with the die 102. For example, the receptacles 106 are attached or fixed to the die 102 such as by an adhesive or fastener. In a variation, the receptacle 106 is a hollow jacket sized to house the fastener 206. For example, the receptacle 106 is cylindrical. In various embodiments, the hollow jacket is insulated such that it protects the fastener 206 from heat of the heated die 102. For example, the hollow jacket includes a thermal insulator such as a ceramic, plastics, mineral wool, fiberglass, polystyrene, cellulose, and/or polyurethane foams. In a refinement, the hollow jacket has a thermal conductivity of not more than 10 W/m·K, or more preferably not more than 1 W/m·K, or even more preferably not more than 0.1 W/m·K.

In various embodiments, the receptacles 106 cooperate with one or more actuators 108. The one or more actuators 108 are arranged such that during actuation the fastener 206 is displaced into the cushion 202 and retained in the cushion 202. For example, an actuator 108 such as a solenoid actuator is disposed adjacent each receptacle 106 opposite the orifice 104. In a refinement, each actuator 108 includes a piston that protrudes from the actuator 108. The actuators 108 are arranged such that the pistons drive the fasteners 206 from the receptacles 106, through the orifices 104 and into the cushion 202 such that when the robotic arm 218 disengages the die 102 from the cushion 202 the one or more fasteners 206 are disposed in the trench 204 and retained in the cushion 202.

In one or more embodiments, the automation system is in communication with a controller (not shown) having a non-transitory computer readable medium having computer executable instructions thereon. In a variation, the controller also includes a processor. In various embodiments, the controller controls automation. For example, the controller is programmed to heat the die 102 and engage/disengage the die 102 with the one or more cushions 202. In a refinement, the die 102 is heated to a threshold temperature before its engaged with a cushion 202. In some embodiments, the controller is programmed to engage/disengage the die with a plurality or series of cushions. While engaged with the cushion, in one or more embodiment, the controller also actuates the one or more actuators 108 such that the one or more fasteners 206 is disposed in the cushion. In a refinement, a plurality or series of fasteners is disposed in a corresponding plurality or series of cushions. In still other embodiments, a cartridge or hopper of fasteners is in communication with the one or more receptacles 106 such that the one or more fasteners are feed to the receptacles for each cushion.

Methods of preparing cushions with fasteners disposed therein are also disclosed. In one or more embodiments, the method includes preparing and/or providing a cushion body (i.e., step 410), heating a die (i.e., step 420), engaging the die with the first cushion body (i.e., step 430), disposing a plurality of fasteners into the cushion body (i.e., step 440), disengaging the cushion body (i.e., step 450), and fastening a trim cover to the cushion (i.e., step 460). In various embodiments, the method is repeated for a plurality or series of cushion bodies (e.g., a first cushion body, a second cushion body, a third cushion body and so on). In a refinement, the die includes one or more die bars (e.g., a plurality of die bars) and each die bar includes a plurality of orifices extending through the die from a first side to a second side (e.g., from the top to the bottom).

In one or more embodiments, the cushion body is foamless such as being made from a plurality of entangled and/or intertwined polymeric strands/filaments as described above and in U.S. patent application identified by Ser. No. 17/741,639. In a variation, the foamless cushion body is produced from extruding a resin through an extrusion die having a plurality of apertures such that a plurality molten polymeric strands are formed. The polymeric strands are then dispensed from a first medium such as air through a funnel and into a second medium such as water such that they become entangled and intertwined into a body of polymeric strands.

In a variation, the die bar is heated by a heating element. For example, ultrasonic heating is used to heat the die and once the die achieves a temperature of at least 100° C., or more preferably at least 105° C. or even more preferably at least 110° C. it is engaged with the cushion body. In various embodiments, during engagement, the die is applied at a pressure/force 60N, or more preferably 75N, or even more preferably 80N such that it defines a number of trenches/channels corresponding to the number of die bars. In one or more embodiments, the die bar is engaged with the cushion body for at least 10 seconds, or more preferably at least 12 seconds, or even more preferably at least 15 seconds. In a variation, the die is engaged with the cushion body by a robotic arm that is responsible for heating the die and applying it to the cushion at the appropriate pressure/force and in the correct position.

In various embodiments, the plurality of fasteners is disposed in the corresponding trenches/channels of the cushion body. In a refinement, the plurality of fasteners is discharged from a receptacle such as a hollow jacket with insulating properties through the die into the cushion body while the die is engaging the cushion body. For example, the fasteners are discharged by one or more corresponding solenoid actuators. After the fasteners are discharged and driven into the cushion body, the die is disengaged from the cushion body such that the plurality of fasteners remains at least partially disposed in the cushion body. In a refinement, the robotic arm disengages the die (e.g., die bars) from the cushion body.

In one or more embodiments, a controller is programmed to execute computer readable instruction such that it actuates the robotic arm to heat, engage, and disengage the die. The instructions also actuate the actuators such that the plurality of fasteners is discharged into the cushion body. In various embodiments, the controller automates the methods such that multiple cushions may be shaped and prepared correctly and efficiently with little or no human labor. In a variation, a trim cover cooperates with the plurality of fasteners. For example, a trim cover may be attached/fastened to the cushion body via the plurality of fasteners.

In one or more embodiments, the processor includes one or more devices selected from high-performance computing systems including high-performance cores, microprocessors, micro-controllers, digital signal processors, microcomputers, central processing units, field programmable gate arrays, programmable logic devices, state machines, logic circuits, analog circuits, digital circuits, or any other device that manipulate signals (analog or digital) based on computer-executable instructions residing in the memory. In variations, the memory includes a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. In a refinement, the non-volatile memory/storage includes one or more persistent data storage devices such as a hard drive, optical drive, tape drive, non-volatile solid state device, cloud storage or any other device capable of persistently storing information.

In one or more embodiment, the executable code/instructions may reside in a software module. In a refinement, the software module includes operating systems and applications. In various embodiments, the software module is compiled or interpreted from a computer program created using a variety of programming languages and/or technologies, including, without limitation, and either alone or in combination, Java, C, C++, C#, Objective C, Fortran, Pascal, Java Script, Python, Perl, and PL/SQL. Non-volatile storage may also include data supporting the functions, features, calculations, and processes.

In some embodiments, the systems described above include computer readable storage media, which is inherently non-transitory, and in various refinements includes volatile or non-volatile, and removable and non-removeable tangible media implemented in any method or technology for storage of information, such as computer-readable instructions, data structures, program modules, or other data. In a variation, computer readable storage media further includes RAM, ROM, erasable programable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. In various embodiments, the computer readable program instructions may be downloaded to a computer, another type of programmable data processing apparatus, or another device form of a computer readable storage medium or to an external computer or external storage device via a network.

In one or more embodiments, the computer readable program instructions stored in a computer readable medium may be used to direct a computer, other types of programmable data processing apparatus, or other devices to function in a particular manner, such that the instructions stored in the computer readable medium produce an article of manufacture including instructions that implement functions, acts, and/or operations described herein. The functions, acts, and/or operations described herein may be re-ordered, processed serially, and/or processed concurrently.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

According to a first aspect of the method described herein, the method includes heating a die (e.g., die bars) defining a plurality of orifices, engaging the die with a first cushion to define a channel in the first cushion, driving a plurality of fasteners from a plurality of hollow jackets cooperating with the die through the plurality of orifices into the first cushion with one or more actuators that cooperate with the receptacles, and disengaging he die from the first cushion such that the plurality of fasteners remain disposed in the first cushion such as in the channel.

According to a second aspect, the die and first cushion of the first aspect or any of the following aspects are engaged by a robotic arm.

According to a third aspect, the method of any of the prior or following aspects wherein the steps are embodied as computer executable instructions on a non-transitory computer readable medium and executed by a processor cooperating with the robotic arm, die, a heating element, and the one or more actuators.

According to a fourth aspect, the method of any of the prior or following aspects includes fastening a trim cover to the first cushion via the plurality of fasteners.

According to a fifth aspect, the method of any of the prior or following aspects includes engaging a second cushion with the die to define a channel in the second cushion, driving a second plurality of fasteners from the plurality of hollow jackets through the plurality of orifices into the second cushion with the one or more actuators, and disengaging the die from the second cushion such that the second plurality of fasteners remains disposed in the channel of the second cushion.

According to a sixth aspect of the assembly described herein, the assembly includes a die (e.g., die bar) to define a cavity (e.g., trench/channel) in a cushion, a receptacle cooperating with the die and aligned with the orifice, and a actuator to drive the fastener from the receptacle, through the orifice, and into the cushion such that the fastener is disposed in the cavity of the cushion. The die includes an orifice that extends from a first side of the die to a second side. The receptacle is disposed on the die such that it receives a fastener. The fastener includes a clip to attach it to a trim assembly. The actuator is a solenoid actuator.

According to a seventh aspect, the die of any of the preceding or following aspects cooperates with a heating element to heat the die.

According to an eighth aspect, the receptacle of any of the preceding or following aspects is insulated or includes a thermal insulator to reduce the heat received from the die to the fastener such that it is not melted or deformed via thermal energy.

According to a nineth aspect, the heating element of any of the preceding or following aspects includes ultrasonic heating.

According to a tenth aspect, the assembly of any of the preceding or following aspects includes an adaptor such as an adaptor plate to install it as an end effector on an automation assembly.

According to an eleventh aspect, the actuator of any of the preceding or following aspects is a solenoid actuator.

According to a twelfth aspect, the fastener(s) of any of the preceding or following aspects cooperates with a trim cover to fasten the trim cover to the cushion.

According to a thirteenth aspect, the assembly of any of the preceding or following aspects cooperates with an automation system for engaging the die with the cushion to define the cavity.

According to a fourteenth aspect of the system disclosed herein, system includes one or more robotic arms, a plurality of die bars defining a plurality of orifices, a plurality of hollow jackets cooperating with the die bar to receive a plurality of fasteners, and an actuator arranged to drive the plurality of fasteners from the plurality of hollow jackets into the cushion assembly. The plurality of die bars is disposed on the one or more robotic arms such that when the plurality of die bars is heated and engages a cushion assembly the die bars define depressed channels in the cushion assembly. The plurality of hollow jackets is aligned with a respective orifices of the plurality of orifices such that a respective fastener of the plurality of fasteners is also aligned with the respective orifice. The actuator is arranged such that it drives each fastener from the hollow jacket through the respective orifice of the die bars into a depressed channel of the cushion.

According to a fifteenth aspect of the system of any of the preceding or following aspects, the system includes a heating element to heat the plurality of die bars.

According to a sixteenth aspect of the system of any of the preceding or following aspects, the system includes a controller programmed to heat the plurality of die bars, engage the plurality of die bars with the cushion assembly after reaching a threshold temperature, and actuate the actuator to drive the fasteners into the depressed channels of the cushion assembly.

According to a seventeenth aspect of the fasteners of any of the preceding or following aspects the fasteners cooperate with a trim cover to attach the trim cover to the cushion assembly.

According to an eighteenth aspect of the die(s) of any of the preceding or following aspects, the die(s) is thermally conductive or include a thermal conductor and the receptacle(s)/hollow jacket(s) is thermally insulating or include a thermal insulator.

According to a nineteenth aspect of the die(s) of any of the preceding or following aspects include iron, aluminum, and/or cooper and the receptacle(s)/hollow jacket(s) include plastic, fiberglass, and/or foam.

According to a twentieth aspect of the cushion assemblies of any of the preceding or following aspects, the cushion assemblies include cushion bodies of entangled and/or intertwined polymeric strands such that depressed channels are formed in the cushion bodies.

What is claimed is:

1. A cushion assembly formed by a method comprising:
heating a die bar, the die bar defining a plurality of orifices;
engaging a first cushion with the die bar to define a channel in the first cushion;
driving a plurality of fasteners from a plurality of hollow jackets cooperating with the die bar through the plurality of orifices into the first cushion with one or more actuators; and
disengaging the die bar from the first cushion such that the plurality of fasteners remains disposed in the channel of the first cushion.

2. The cushion assembly of claim 1, wherein the cushion assembly includes a plurality of entangled polymeric strands forming a cushion body, the cushion body having the channel defined therein, the channel at least partially delimited by a skin and the plurality of fasteners disposed in the skin delimiting the channel, the plurality of fasteners arranged to cooperate with a trim cover.

3. The cushion assembly of claim 2, wherein the skin has a thickness of at least 1.75 mm.

4. The cushion assembly of claim 2, wherein the skin has a thickness of at least 2.0 mm.

5. The cushion assembly of claim 2, wherein the plurality of fasteners extends through the skin.

6. An assembly comprising:
a die defining a cavity in a cushion, the die defining an orifice;
a receptacle cooperating with the die and aligned with the orifice, the receptacle arranged to receive a fastener; and
an actuator to drive the fastener from the receptacle and through the orifice into the cushion such that the fastener is disposed in the cavity of the cushion.

7. The assembly of claim 6, wherein the die cooperates with a heating element, the heating element heating the die.

8. The assembly of claim 7, wherein the receptacle is insulated, reducing heat received from the die to the fastener.

9. The assembly of claim 7, wherein the heating element is an ultrasonic heater.

10. The assembly of claim 6, wherein the actuator is a solenoid actuator.

11. The assembly of claim 6, wherein the fastener cooperates with a trim cover to fasten the trim cover to the cushion.

12. An automation system cooperating with the assembly of claim 6 to engage the die to the cushion and define the cavity.

13. A system comprising:
one or more robotic arms;
a plurality of die bars defining a plurality of orifices and disposed on the one or more robotic arms such that when the plurality of die bars is heated and engages a cushion assembly the die bars define depressed channels in the cushion assembly;
a plurality of hollow jackets cooperating with the die bars to receive a plurality of fasteners such that each fastener of the plurality of fasteners is aligned with a respective orifice of the plurality of orifices; and
an actuator arranged to drive the plurality fasteners from the plurality of hollow jackets through the plurality of orifices into the cushion assembly such that the plurality of fasteners is disposed in the depressed channels.

14. The system of claim 13, further comprising a non-transitory computer readable medium having computer executable instruction thereon to be executed by a processor cooperating with the one or more robotic arm, and the actuator.

15. The system of claim 13, further comprising a heating element to heat the plurality of die bars.

16. The system of claim 13, further comprising a controller programmed to:
heat the plurality of die bars;
engage the plurality of die bars with the cushion assembly after reaching a threshold temperature; and
actuate the actuator to drive the fasteners into the depressed channels of the cushion assembly.

17. The system of claim 13, wherein the fasteners cooperate with a trim cover to attach the trim cover to the cushion assembly.

18. The system of claim 13, wherein the plurality of die bars includes a thermal conductor, and the plurality hollow jackets include a thermal insulator.

19. The system of claim 18, wherein the plurality of die bars include iron, aluminum, and/or copper and the plurality of hollow jackets includes plastic, fiberglass, and/or foam.

20. The system of claim 13, wherein the cushion assembly includes cushion bodies of entangled polymeric strands, and the depressed channels are formed in the cushion bodies.
